(19) United States
(12) Patent Application Publication
(10) Pub. No.: US 2021/0035132 A1
(43) Pub. Date: Feb. 4, 2021

(54) PREDICTING DIGITAL SURVEY RESPONSE QUALITY AND GENERATING SUGGESTIONS TO DIGITAL SURVEYS

(71) Applicant: Qualtrics, LLC, Provo, UT (US)

(72) Inventors: Milind Kopikare, Draper, UT (US); Zachary Jensen, Provo, UT (US); Justin Ricks, Eagle Mountain, UT (US); Benjamin Meline, Orem, UT (US); PJ Tatlow, Spanish Fork, UT (US); Gregory Burnham, Springville, UT (US); Jeffrey Whiting, Salem, UT (US); Jamie Morningstar, Orem, UT (US); Zheng Fang, Kenmore, WA (US)

(21) Appl. No.: 16/983,903

(22) Filed: Aug. 3, 2020

Related U.S. Application Data
(60) Provisional application No. 62/881,817, filed on Aug. 1, 2019.

(51) Int. Cl. G06Q 30/02; G06K 9/62; G06N 20/00

(52) U.S. Cl. CPC G06Q 30/0203; G06N 20/00; G06K 9/6256

(57) ABSTRACT

The present disclosure relates to a response prediction system that intelligently optimizes the quality of responses to a survey by predicting response quality and generating suggested changes (e.g., improving question ordering, question phrasing, question type, etc.). For example, in one or more embodiments, the response prediction system predicts response quality based on extracted survey characteristics. The response prediction system uses the predicted response quality to generate suggested changes before publishing the survey. Additionally, the response prediction system collects feedback by analyzing responses after the survey has been published to update suggested changes specific to the survey.

### RELATED APPLICATIONS

This application claims priority to and the benefit of U.S. Provisional Patent Application No. 62/881,817, filed on Aug. 1, 2019, which is incorporated herein by reference in its entirety.

### BACKGROUND

Recent advancements in computing devices and networking technology have led to a variety of innovations in composing and creating digital surveys to gather information. For example, conventional survey creation systems can enable individuals to compile lists of questions into digital surveys and distribute the digital survey to respondents. Indeed, many conventional survey creation systems provide tools, templates, libraries, interfaces, and other options to assist individuals to create digital surveys.

Despite these and other advances, however, conventional survey creation systems continue to suffer from a number of limitations in relation to functionality, accuracy, and efficiency. To illustrate, the tools provided by many conventional survey creation systems often face shortcomings relative to functionality. More specifically, although many conventional survey creation systems enable individuals to build various types of surveys via survey building tools, the survey building tools often fail to create or optimize functional surveys. In particular, many surveys created by conventional survey creation systems often result in effectively useless responses. For example, conventional survey creation systems often utilize illogical or confusing questions, questions that cannot render across a variety of computing devices, poorly thought-out questions (e.g., questions that ask for personal details that people are not willing to share), or questions with other limitations or defects. Such surveys, even if sent to enough recipients to generate a statistically significant sample, often collect low-quality answers. Thus, many conventional survey creation systems fail to create functional and useful surveys that result in functional and useful response data.

As a result, conventional survey creation systems are often inefficient with respect to computing and storage resources. In particular, conventional survey creations systems often fail to identify a survey as unproductive until after the survey has been published, distributed, and responses have been collected. For example, conventional survey creation systems dedicate computing resources to generating and sending unproductive surveys to numerous users. Conventional survey creation systems will often use additional resources to collect and store responses to the survey. Typically, conventional survey creations systems must dedicate additional computing resources to analyze all the responses before identifying the responses and/or the survey as unproductive. Thus, conventional survey creation systems are often inherently inefficient and waste significant computing and storage resources based on managing unproductive surveys and unproductive survey response data.

Additionally, due to the above-discussed disadvantages, conventional survey creation systems often produce inaccurate survey results and a survey administrator will only become aware of the inaccurate survey results after administering a survey to an audience over a period of time. Though some conventional survey creation systems have attempted to provide users with a loose prediction of the quality of a survey, predictions generated by such conventional survey creation systems are often too simplistic. For example, while conventional survey creation systems can determine that a survey is free of grammatical and spelling errors, conventional survey creation systems often have difficulty evaluating the efficacy of survey questions upfront and in a meaningful way to allow the system to correct issues with a survey prior to survey administration. In other words, conventional survey creation systems often have no effective means to accurately identify unproductive surveys that result in a waste of computational resources, cost, and time.

These along with additional problems and issues exist with regard to conventional survey creation systems.

### SUMMARY

Embodiments of the present disclosure provide benefits and/or solve one or more of the foregoing or other problems in the art with systems, computer media, and methods for improving survey creation by providing customized suggestions to users during the creation of digital surveys to improve survey quality and effectiveness. For example, in one or more embodiments, the disclosed systems analyze survey and response data to provide real-time feedback to survey publishers during the creation of a survey. In particular, the disclosed systems can provide specific suggestions for editing individual survey questions and the survey as a whole to optimize the quality of response data. Additionally, as the disclosed systems receive responses to surveys, the disclosed systems can store and analyze response data to further personalize feedback and suggestions.

To illustrate, the disclosed systems can receive a survey from an administrator. The disclosed systems extract survey characteristics by analyzing the survey. Based on the extracted survey characteristics, the disclosed systems can predict a response's quality and identify suggested changes. The disclosed systems can present, within a survey evaluation graphical user interface, the response quality and the suggested changes. Additionally, the disclosed systems can publish the survey and receive responses from respondents. Based on the responses, the disclosed systems can update the response quality and the suggested changes and present the updated response quality and suggested changes via the survey evaluation graphical user interface.

The following description sets for additional features and advantages of one or more embodiments of the disclosed systems, computer media, and methods. In some cases, such features and advantages will be obvious to a skilled artisan from the description or may be learned by the practice of the disclosed embodiments.

### BRIEF DESCRIPTION OF THE DRAWINGS

The detailed description refers to the drawings briefly described below.

FIG. 1 illustrates a block diagram of an environment in which a response prediction system can operate in accordance with one or more embodiments.

FIG. 2 illustrates an example sequence diagram of providing response quality and recommended changes in accordance with one or more embodiments.

FIG. 3 illustrates an overview for presenting predicted response quality and suggested changes to an administrator before the response prediction system publishes a survey in accordance with one or more embodiments.

FIG. 4 illustrates additional detail with regard to generating question suggested changes and global survey suggested changes in accordance with one or more embodiments.

FIGS. 5A-5C illustrate a series of example question evaluation graphical user interfaces for presenting suggested changes in accordance with one or more embodiments.

FIGS. 6A-6B illustrate a series of example survey evaluation graphical user interfaces for presenting global survey suggested changes in accordance with one or more embodiments.

FIG. 7 illustrates an overview for presenting updated response quality and updated suggested changes to an administrator in accordance with one or more embodiments.

FIG. 8 illustrates additional detail with regard to updating suggested changes in accordance with one or more embodiments.

FIG. 9 illustrates an example response evaluation graphical user interface for presenting updated response quality and updated suggested changes in accordance with one or more embodiments.

FIG. 10 illustrates a flowchart of a series of acts in a method of providing survey suggested changes in accordance with one or more embodiments.

FIG. 11 illustrates a block diagram of an example computing device for implementing one or more embodiments of the present disclosure.

FIG. 12 illustrates an example network environment of a response prediction system in accordance with one or more embodiments described herein.

### DETAILED DESCRIPTION

This disclosure describes one or more embodiments of a response prediction system that analyzes surveys and intelligently provides real-time suggestions to improve quality of survey responses. More particularly, the response prediction system analyzes the characteristics of created surveys before they are published. Based on an assessment of the pre-published survey, the response prediction system can generate an initial survey report that includes a predicted response quality. Additionally, the initial survey report can include suggested changes to improve the predicted response quality. Furthermore, the response prediction system can conduct additional analysis after publishing the survey. In particular, the response prediction system continuously retrieves feedback (e.g., survey responses and survey response quality) to generate an updated survey report with predictions and suggested changes based on data specific to the published survey.

To illustrate, in one or more embodiments, the response prediction system receives a survey comprising one or more survey questions. The response prediction system extracts survey characteristics (e.g., survey length, number and type of questions, etc.) from the received survey and survey questions. The response prediction system generates a predicted response quality based on the extracted survey characteristics. Furthermore, based on the predicted response quality, the response prediction system generates suggested changes (e.g., remove, move, or amend questions, add translations for certain questions, amend a question for device compatibility, etc.) and provides the suggested changes at a client device associated with an administrator.

As mentioned above, the response prediction system predicts response quality for a received survey. In general, the response prediction system does not only evaluate the quality of the survey but also predicts response quality based on analyzed survey characteristics. For example, the response prediction system extracts survey characteristics such as question word counts, character counts, readability index scores, and others. The response prediction system may utilize a combination of a statistical regression model and a machine learning model to analyze historical survey data to predict response quality based on the extracted characteristics. More specifically, the response prediction system generates response quality scores for response quality classes applicable to both specific questions (e.g., responses are likely irrelevant to what the question is asking) and for the survey as a whole (e.g., the survey is likely to have contradicting answers or repetitive answers).

Additionally, as mentioned, the response prediction system does not only predict response quality, the response prediction system also generates suggested changes. For example, the response prediction system can, based on the predicted response quality, present recommendations for improving the predicted response quality. In particular, the response prediction system generates scores for a number of response quality classes. The response prediction system identifies target response quality classes by determining which response quality scores fall below (or above) a corresponding threshold. The response prediction system utilizes a combination of a statistical regression model and a machine learning model to identify target survey characteristics that can be modified to boost the target response quality class. Thus, the response prediction system identifies the most efficient method to improve the predicted response quality.

The response prediction system conducts additional analysis after the survey has been administered or published to survey respondents. For example, the response prediction system collects and analyzes received responses to generate suggested responses specific to the particular survey. The response prediction system periodically retrieves survey responses and generates scores for the plurality of response quality classes based on the actual responses to the survey questions. Based on the received responses, the response prediction system generates suggested changes. In particular, the response prediction system can use the retrieved responses to update a specific dataset that contains survey data specific to an administrator, an organization, or administrators/organizations with shared characteristics. Thus, the response prediction system can utilize data from the specific dataset to generate suggested changes specific to an administrator, organization, or even a type of survey respondent, thus allowing for survey modifications during the administration of a survey that improve the survey results.

The response prediction system provides many advantages and benefits over conventional systems and methods. For example, the response prediction system can improve the functionality of digital survey systems. In particular, while conventional systems might collect statistically significant samples of low-quality responses, the response prediction system can minimize the likelihood of an unproductive survey. In particular, the response prediction system can predict response quality of surveys to identify suggested changes. By implementing the suggested changes, the response prediction system can improve the actual response quality of surveys.

Additionally, the response prediction system makes technical improvements with respect to efficiency. For example, the response prediction system can identify ways to improve survey response quality and can present suggested changes to an administrator before a survey has even been published. By doing so, the response prediction system can improve the predicted quality of survey responses even before publishing the survey. Thus, the response prediction system can reduce the amount of processing power and storage space traditionally dedicated to sending, receiving, and processing surveys and unproductive results. Instead, most processing and storage resources utilized by the response prediction system are used to collect productive survey responses.

The response prediction system is also more accurate relative to conventional systems. For example, in contrast to conventional survey creation systems that generate loose predictions of survey quality, the response prediction system can generate a response quality prediction. Because the response prediction system suggests changes based on predicted response quality, the response prediction system can generate suggested changes that result in more accurate survey results. Furthermore, the response prediction system accesses various datasets including a general dataset that stores all survey data across the response prediction system and a specific dataset that stores survey data specific to a survey, an administrator, entity, or administrators/entities that share common characteristics. Thus, the response prediction system can predict response quality specific to a particular survey associated with an administrator, entity, or administrators/entities that share the common characteristics.

As is apparent by the foregoing discussion, the present disclosure utilizes a variety of terms to describe features and advantages of the response prediction system. Additional detail is now provided regarding these and other terms used herein. For example, as used herein, the terms “survey question,” “question prompt,” “survey prompt,” or simply “question” refer to an electronic communication used to collect information. In particular, the term “question” can include an electronic communication that causes a client device to present a digital query that invokes or otherwise invites a responsive interaction from a respondent of a respondent client device. While a question primarily includes a survey question, in some embodiments, a question includes a statement or comment of instruction or information to a respondent.

As used herein, the term “survey” refers to an electronic communication to collect information. In particular, the term “survey” can include an electronic communication comprising one or more survey questions. For example, a single survey can include a number of different types of survey questions including multiple choice, matrix, and others. In one or more embodiments, a survey can refer to information collected through channels other than direct surveys, such as online forums or other information received from online sources.

As used herein, the term “survey characteristics” refers to features of a survey. In particular, the term “survey characteristics” can include traits of individual survey questions and/or traits of the survey as a whole. More specifically, the term “survey question characteristics” or “question characteristics” refer to traits of an individual survey question. For example, survey question characteristics can refer to the question type, number of characters, number of polysyllabic words, coordinating conjunctions, etc. in a survey question. The term “global survey characteristics” refer to traits of the global survey. For example, “global survey characteristics” can refer to number of questions, proportions of types of questions, question similarity, etc. of the survey as a whole.

As used herein, the terms “survey response” or simply “response” refer to electronic data provided in response to a survey. The term “survey response” refers to electronic data including content and/or feedback based on user input form the respondent in reply to the survey. For example, the term “survey response” can include answers or responses to a survey as a whole (e.g., a percentage of questions answered). Additionally, the term “question response” or “survey question response” specifically refers to electronic data including content based on user input from the respondent in reply to a particular survey question. For example, “question response” includes a respondent's input in reply to a specific question. Furthermore, for purposes of describing one or more embodiments disclosed herein, reference is made to survey questions and survey responses. One will appreciate that while reference is made to survey-related questions and responses, the same principles and concepts can be applied to other types of content items.

As used herein, the term “response quality” refers to the quality of a survey response. Generally, “response quality” refers to the productivity or usability of a response. For example, response quality can include scores for a number of response quality classes including repeat answers, completion rate, repetitive answers, length of answers, specificity of answers, etc. Scores for the response quality classes can comprise fractional numbers indicating the number of surveys that have response class quality scores over a corresponding threshold (e.g., 55/100 surveys have repeat answers).

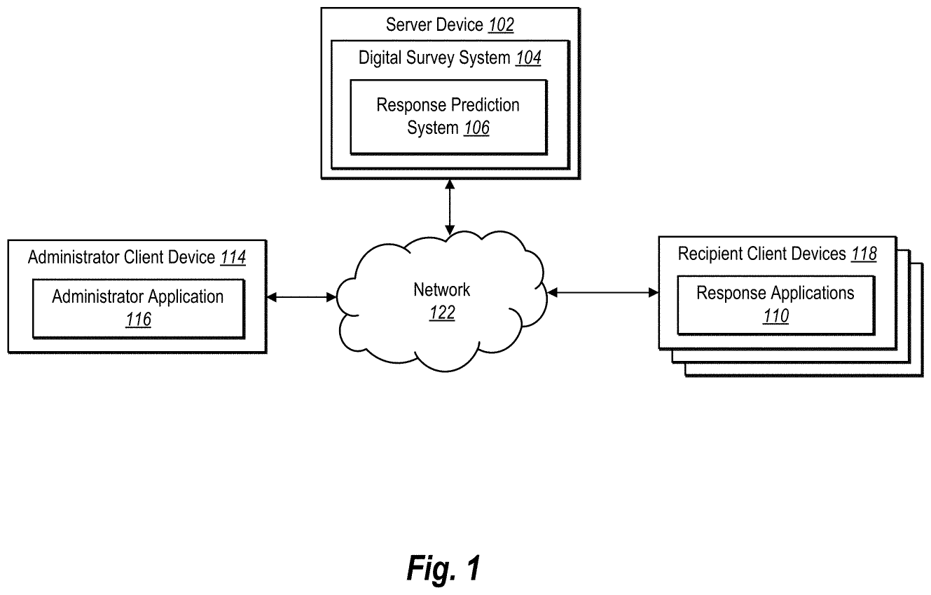

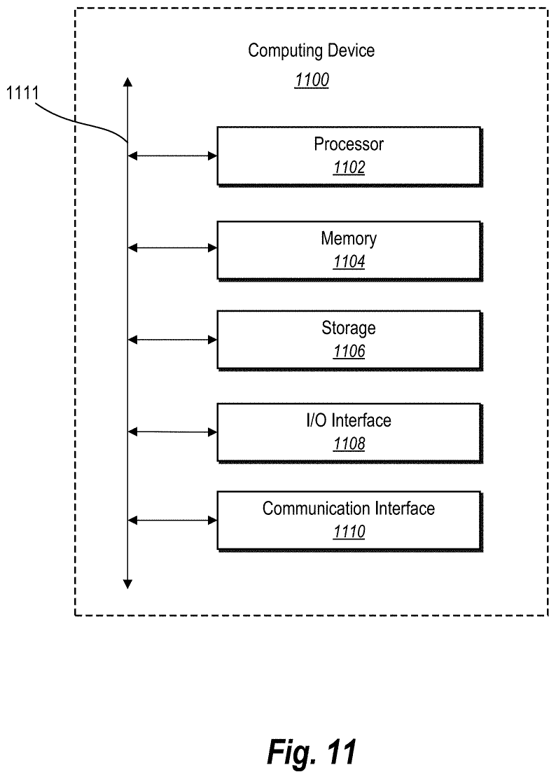

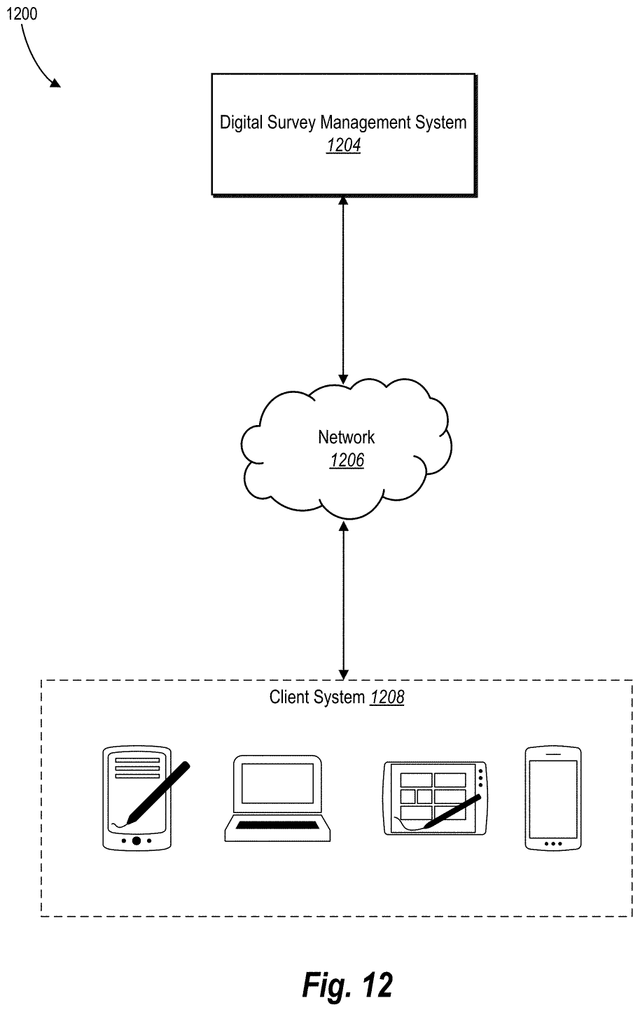

Additional detail will now be provided regarding the question recommendation system in relation to illustrative figures portraying example embodiments. For example, FIG. 1 illustrates a schematic diagram of an environment in which the question response prediction system 106 can operate in accordance with one or more embodiments. As illustrated, environment includes a server device 102 and client devices (i.e., administrator client device 114 and recipient client devices 118) connected by network 122. Additional details regarding the various computing devices (e.g., the server device 102, the administrator client device 114, recipient client devices 118, and network 122) are explained below with respect to FIGS. 11 and 12.

As shown, the server device 102 hosts a digital survey system 104 and the response prediction system 106. In general, the digital survey system 104 facilitates the creation, administration, and analysis of electronic surveys. For example, the digital survey system 104 enables a user (e.g., an administrative user) via the administrator client device 114, to create, modify, and publish a digital survey that includes various questions (e.g. electronic survey questions). In addition, the digital survey system 104 provides survey questions to recipients, and collects responses from respondents (i.e., responding recipients/users) via the recipient client devices 118.

In addition, the digital survey system 104 includes the response prediction system 106. In various embodiments, the response prediction system 106 predicts a response quality and presents suggested changes to administrators associated with the administrator client device 114. In particular, the response prediction system 106 analyzes a survey before it is published to generate recommendations in reordering, rephrasing, and otherwise editing surveys and survey questions to improve a respondent's experience with the survey, which in turn, results in more completed surveys and higher-quality responses by respondents. Furthermore, after the digital survey system 104 publishes the survey, the response prediction system 106 further fine tunes recommendations based on collected responses. To briefly illustrate, the digital survey system 104 receives or otherwise accesses a survey. The response prediction system 106 analyzes the survey to extracts survey characteristics. The response prediction system 106 predicts a response quality based on the extracted survey characteristics and generates suggested changes to the survey. The response prediction system 106 provides the suggested changes to the administrator via the administrator client device 114.

As shown, the environment includes the administrator client device 114 and the respondent client devices 118. The administrator client device 114 includes an administrator application 116 (e.g., a web browser or native application) that enables a user (e.g., an administrator) to access the digital survey system 104 and/or the response prediction system 106. For example, while creating or editing a survey using the administrator application 116, the response prediction system 106 provides suggested changes to the user to make to the survey. Furthermore, after the digital survey system 104 publishes the survey and the digital survey system 104 begins collecting responses, the response prediction system 106 can provide updated suggested changes to the user to improve future response quality. Similarly, the respondent client devices 118 include response applications 120 that enable respondents to complete digital surveys provided by the digital survey system 104. In some embodiments, the administrator application 116 and/or the response applications 120 include web browsers that enable access to the digital survey system 104 and/or the response prediction system 106 via the network 122.

Although FIG. 1 illustrates a minimum number of computing devices, the environment 100 can include any number of devices, including any number of server devices and/or client devices. In addition, while the environment 100 shows one arrangement of computing devices, various arrangements and configurations are possible. For example, in some embodiments, the administrator client device 114 may directly communicate with the server device 102 via an alternative communication network, bypassing the network 122.

In various embodiments, the response prediction system 106 can be implemented on multiple computing devices. In particular, and as described above, the response prediction system 106 may be implemented in whole by the server device 102 or the response prediction system 106 may be implemented in whole by the administrator client device 114. Alternatively, the response prediction system 106 may be implemented across multiple devices or components (e.g., utilizing the server device 102 and the administrator client device 114).

To elaborate, in various embodiments, the server device 102 can also include all, or a portion of, the response prediction system 106, such as within the digital survey system 104. In addition, server device 102 can include multiple server devices. For instance, when located on the server device 102, the response prediction system 106 includes an application running on the server device 102 or a portion of a software application that can be downloaded to the administrator client device 114 (e.g., the administrator application 116). For example, the response prediction system 106 includes a networking application that allows an administrator client device 114 to interact (e.g., create surveys) via the network 122 and receive suggestions (e.g., suggested changes) from the response prediction system 106 to optimize response quality.

The components 104-112 and 116 can include software, hardware, or both. For example, the components 104-112 and 116 include one or more instructions stored on a computer-readable storage medium and executable by processors of one or more computing devices, such as a client device or a server device. When executed by the one or more processors, the computer-executable instructions of the server device 102 and/or the administrator client device 114 can cause the computing device(s) to perform the feature learning methods described herein. Alternatively, the components 104-112 and 116 can include hardware such as a special-purpose processing device to perform a certain function or group of functions. Alternatively, the components 104-112 and 116 can include a combination of computer-executable instructions and hardware.

Furthermore, the components 104-112 and 116 are, for example, implemented as one or more operating systems, as one or more stand-alone applications, as one or more modules of an application, as one or more plug-ins, as one or more library functions or functions called by other applications and/or as a cloud computing model. Thus, the components 104-112 and 116 can be implemented as a stand-alone application, such as a desktop or mobile application. Furthermore, the components 104-112 and 116 can be implemented as one or more web-based applications hosted on a remote server. The components 104-112 and 116 can also be implemented in a suite of mobile device applications or “apps.”

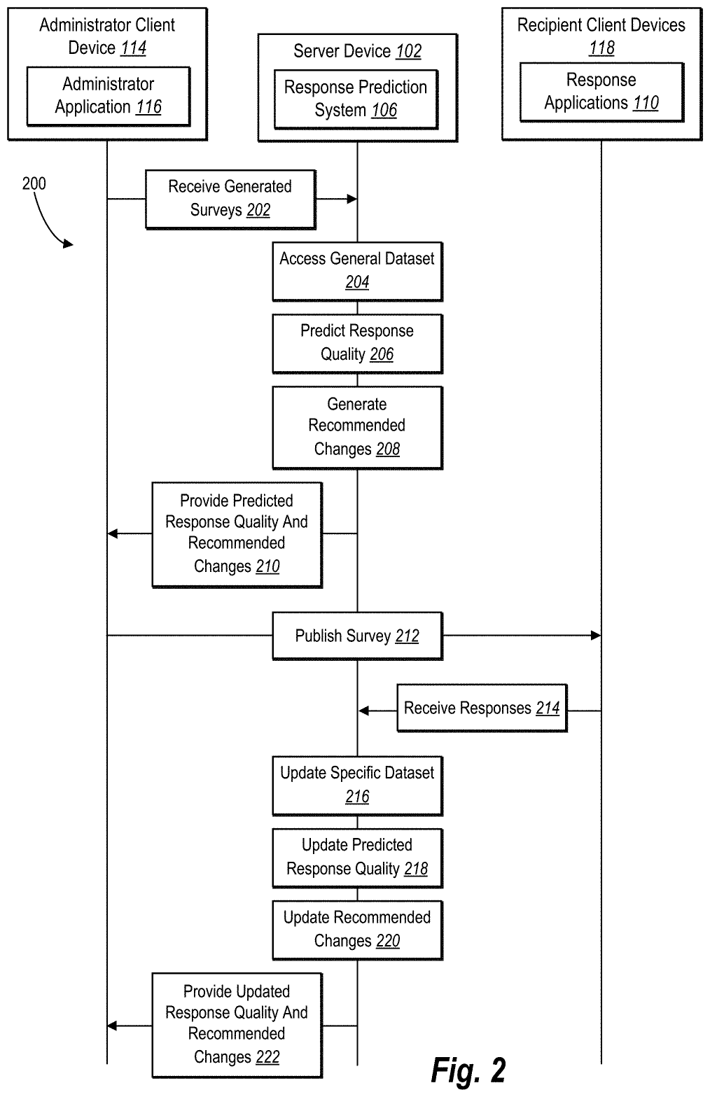

As an overview, the response prediction system 106 can utilize a machine learning model and/or a statistical model to predict the response quality for survey questions and generate suggested changes. To elaborate, FIG. 2 and the accompanying discussion provide a general overview of generating and providing predicted response quality and recommended changes to the administrator client device 114. As mentioned, FIG. 2 illustrates a sequence diagram 200 for providing updated response quality and updated recommended changes in accordance with one or more embodiments. As shown, the sequence diagram 200 includes the administrator client device 114, the server device 102, and the recipient client devices 118. The administrator client device 114 includes the administrator application 116, the server device 102 includes the response prediction system 106, and the recipient client devices 118 include the recipient application 120. While not illustrated the response prediction system 106 can be implemented within a digital survey system located on the server device(s) 102.

As shown in FIG. 2, the response prediction system 106 receives generated surveys 202 from the administrator client device 114. For example, an administrator (i.e., user) can generate numerous surveys over time and provide the surveys to the response prediction system 106. In some embodiments, the response prediction system 106 receives a collection of surveys from additional or alternative sources, such as surveys stored on the digital survey system. Each of the generated surveys can include multiple questions. In addition, each of the questions or prompts can include specific words or phrases of text that make up the question. Further, the survey questions can vary by question type (e.g., multiple choice, open-ended, ranking, scoring, summation, demographic, dichotomous, differential, cumulative, dropdown, matrix, net promoter score (NPS), single textbox, heat map, etc.).

As shown in FIG. 2, the response prediction system 106 can access a general dataset 204. The general dataset includes stored survey data from previous surveys. For instance, the response prediction system 106 can access the general dataset to retrieve past survey data. In particular, the response prediction system 106 can access survey data including survey characteristics, responses, and response quality. For example, the response prediction system 106 can access survey data for previous surveys submitted to the digital survey system 104. Additionally, the response prediction system 106 can access survey data submitted by users in a same class (e.g., same industry, same company, same survey type, etc.) of the administrator associated with the administrator client device 114.

The response prediction system 106 can predict response quality 206 for the received surveys. Generally, the response prediction system 106 extracts survey characteristics from the received surveys. By comparing the survey characteristics from the received surveys and past survey characteristics and past survey response qualities, the response prediction system 106 predicts response qualities for the received surveys. In one or more embodiments, the response prediction system 106 can apply a machine learning model, a statistical model, or a combination of both to predict response qualities. For example, the response prediction system 106 can predict response quality classes such as completion rate, response relevance, response contradiction, response similarity, etc.

Based on the predicted response quality, and as illustrated in FIG. 2, the response prediction system 106 generates recommended changes 208. For example, the response prediction system 106 can generate recommended changes based on the predicted response quality. In at least one embodiment, the response prediction system 106 identifies target response quality classes that fall below (or above) a corresponding threshold and identifies recommended changes based on the target response quality classes. For example, based on determining that the response relevance for a particular survey question is below a particular threshold, the response prediction system 106 can generate a recommendation to simplify language of the particular survey question to clarify the meaning of the question.

As illustrated, the response prediction system 106 provides the predicted response quality and recommended changes 210 to the administrator client device 114. As will be discussed in additional detail below, the response prediction system 106 provides a graphical user interface that provides real-time or near-real-time recommended changes. In particular, the response prediction system 106 provides question-level suggested changes for a survey question in real time as the server device 102 receives the survey question. Additionally, when the server device 102 has received all the survey questions in the survey, the response prediction system 106 provides global survey recommended changes. Thus, the response prediction system 102 provides the administrator with the option to improve response quality for a survey before publishing a survey.

As further shown in FIG. 2, the administrator client device 114 signals the server device 102 to publish the survey 212. The server device 102 sends the survey to one or more recipient client devices 118. The response prediction system 106 receives responses 214 from the recipient client devices 118, as illustrated in FIG. 2. In particular, the response prediction system 106 receives responses to survey questions over time. Thus, as the response prediction system 106 receives responses 214, the response prediction system 106 can update predicted response quality and update recommended changes for the published survey to improve response quality of future surveys. In short, by receiving responses 214, the response prediction system 106 can use received responses to detect poor response quality and generate suggested changes to improve the response quality of future responses for the published survey.

Based on receiving responses from the recipient client devices, the server device 102 updates a specific dataset 216. Generally, the specific dataset stores survey data for a user, entity, or group of entities that share particular characteristics. In particular, by updating a specific dataset, the response prediction system 106 improves the accuracy of predicted response quality for future surveys. For example, respondents may have more patience to complete surveys for more popular entities and have less patience to complete surveys for other less-popular entities. Thus, the response prediction system 106 updates a specific dataset for individual entities to generate more accurate response quality predictions that are specific to the entity. In at least one embodiment, the response prediction system 106 updates a specific dataset for a class of entities (i.e., entities that share a characteristic). Additionally, by updating the specific dataset 216, the response prediction system 106 can improve the accuracy of the response prediction system 106 in evaluating the published survey.

As illustrated in FIG. 2, the response prediction system 106 updates the predicted response quality 218 for the published survey. In general, the response prediction system 106 uses the received responses, to update the predicted response quality 218 for the received survey. The response prediction system 106 evaluates the response quality of received responses for a plurality of response qualities. In at least one embodiment, the response prediction system 106 updates the predicted response quality. The response prediction system 106 compares the received response quality with the predicted response quality to update the response quality 218.

Based on the updated response quality, the response prediction system 106 updates recommended changes 220. For example, if the updated response quality identifies different response quality classes that fall below their corresponding threshold, the response prediction system 106 accordingly updates recommended changes 220. In at least one embodiment, the response prediction system 106 utilizes a machine learning model to identify updated recommended changes by comparing the predicted response quality with the updated response quality. The response prediction system 106 provides updated response quality and recommended changes 222 to the administrator client device 114. In particular, the response prediction system 106 updates a response prediction graphical user interface to present the updated recommended changes.

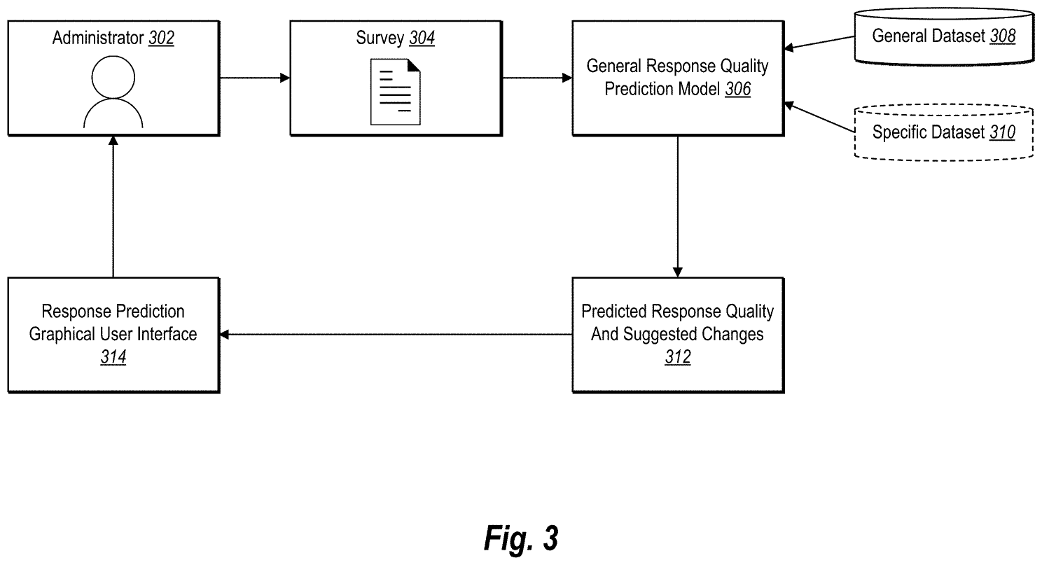

As mentioned previously, the response prediction system 106 can provide real-time feedback to an administrator for improving survey response quality. FIG. 3 provides a general overview for how the response prediction system 106 presents predicted response quality and suggested changes to an administrator 302 associated with the administrator client device 114. In general, FIG. 3 illustrates the response prediction system 106 receiving a survey 304 with survey questions from the administrator 302. The response prediction system 106 utilizes general response quality prediction model 306 to access a general dataset 308 (and optionally, a specific dataset 310) to generate predicted response quality and suggested changes 312. The response prediction system 106 presents the predicted response quality and suggested changes 312 to the administrator 302 via the response prediction graphical user interface 314.

As illustrated in FIG. 3, the response prediction system 106 receives the survey 304 from the administrator 302 via the administrator client device 114. In at least one embodiment, the survey 304 represents a received survey question. In at least one other embodiment, survey 304 represents an entire survey received by the response prediction system 106. The response prediction system 106 can receive a question of a survey from the administrator 302.

The response prediction system 106 analyzes the received survey question using the general response quality prediction model 306. In particular, the general response quality prediction model accesses the general dataset 308 to analyze the received survey 304. The general dataset 308 stores historical (or past) survey data associated with past surveys and their corresponding responses. For example, the general dataset 308 stores past survey characteristics and past response qualities. Thus, the general response quality prediction model 306 can compare past survey characteristics with the survey characteristics from the present survey to model and predict response quality.

In cases where the response prediction system 106 does not have sufficient historical survey data specific to the administrator 302, the response prediction system 106 accesses the general dataset 308 to generate predictions and suggested changes. For example, if the administrator 302 has never submitted a survey (or has submitted only a few surveys) to the response prediction system 106, the response prediction system 106 accesses past survey data for all historical surveys in the general dataset 308. Thus, even if the response prediction system 106 has not stored past survey data in association with the administrator 302, the response prediction system 106 may still generate predicted response quality and suggested changes.

Optionally, the general response quality prediction model 306 can access the specific dataset 310 to generate the predicted response quality and suggested changes 312. The specific dataset 310 can store survey data for past surveys submitted by the administrator 302. In at least one embodiment, the specific dataset 310 stores survey data for surveys submitted by the administrator 302 and other users associated with the same entity (e.g., company) as the administrator 302. In at least one other embodiment, the specific dataset 310 stores survey data for entities that share a characteristic. For example, the specific dataset 310 can store survey data for surveys submitted by hospitals generally. In at least one embodiment, the specific dataset 310 stores survey data for recipients sharing a certain characteristic. For example, the specific dataset 310 can store past survey data for surveys sent to doctors.

Moreover, the specific dataset can be based on similar types of surveys. For example, if a survey is an employee engagement survey, then the specific dataset 310 could include other employee engagement surveys so that the survey characteristics and response quality align well with the new employee engagement survey. As another example, if the survey is a customer experience survey, then the specific dataset 310 could include other customer experience surveys so that the survey characteristics and response quality align well with the new customer experience survey. In one or more embodiments, the response prediction system 106 determines the type of survey (e.g., based on analyzing the type of questions/audience/etc. or based on asking the administrator to define the type of survey) and then selects survey data to include the specific dataset 310. For example, the response prediction system 106 can extract or determine various survey attributes to then use to select survey data for use within the specific dataset to predict response quality and suggest changes to the survey to increase response quality. Survey attributes can include type of survey (e.g., employee engagement survey, customer experience survey, product experience survey), size of company, size of audience, frequency of survey being sent, method of administering the survey (e.g., email, instant message, web), or other attributes known in the art.

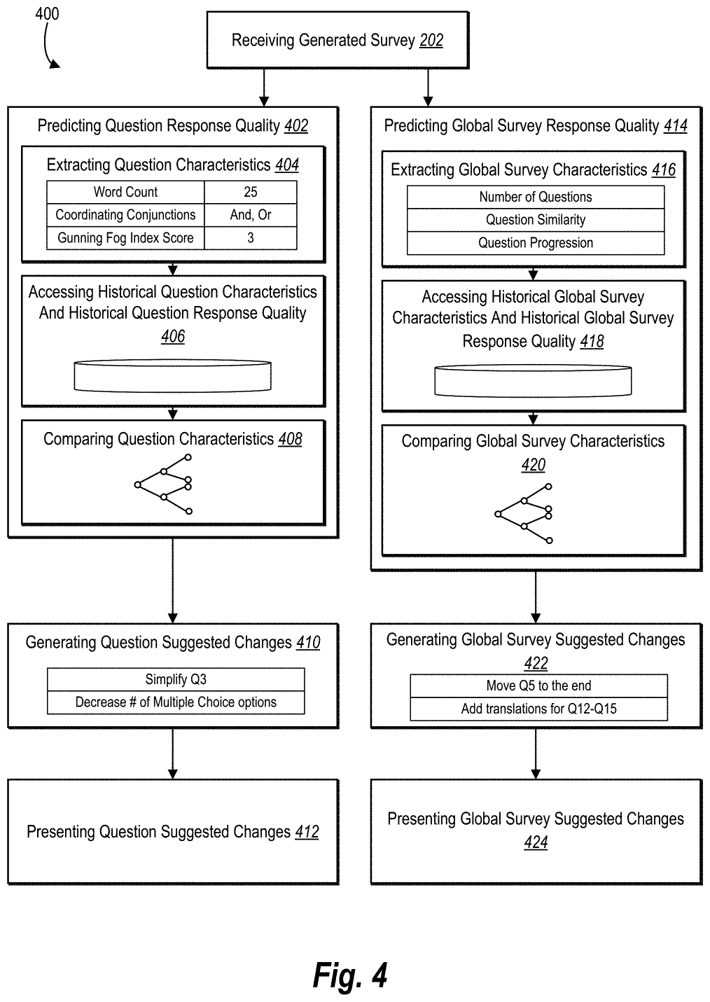

The process by which the general response quality prediction model 306 generates the predicted response quality and suggested changes 312 will be discussed in detail below with respect to FIG. 4. As mentioned previously, the response prediction system 106 utilizes the general response quality prediction model 306 to generate the predicted response quality and suggested changes 312. In particular, FIG. 4 illustrates a series of acts 400 for presenting question suggested changes 422 (i.e., question-specific change) and presenting global survey suggested changes 424. As illustrated, series of acts 400 begins with receiving a generated survey 202. As illustrated, the response prediction system 106 completes two types of analysis for a received survey—question-specific analysis and global survey analysis.

FIG. 4 provides an overview of how the response prediction system 106 generates, for presentation, question-level suggested changes. The response prediction system 106 performs act 402 of predicting question response quality. Predicting question response quality 402 includes act 404 of extracting question characteristics, act 406 of accessing historical question characteristics and historical question response quality, and act 408 of comparing question characteristics. Based upon predicting question response quality 402, the response prediction system 106 generates question suggested changes 410 and presents question suggested changes 412.

As illustrated in FIG. 4, the response prediction system 106 extracts question characteristics 404. In particular the response prediction system 106 extracts various question characteristics. For example, and as illustrated, the response prediction system 106 can determine the number of words (e.g., 25) in a question, and/or the number and type of coordinating conjunctions (e.g., “and, or”). In at least one embodiment, the response prediction system 106 performs a semantic analysis of the question to extract the question type (e.g., multiple choice question, text entry question, matrix question, etc.). Additionally, the response prediction system 106 can extract a readability score for the received question. For example, in at least one embodiment, the response prediction system 106 extracts a gunning fog index score. Though not illustrated, the response prediction system 106 extracts additional question characteristics including number of characters, number of polysyllabic words (e.g., words with 3 or more syllables), the number of choices for multiple choice questions, number and difficulty of identified jargon or otherwise hard to understand terms, the number of topics in the question, etc. In addition, the response prediction system 106 look at device compatibility issues based on question characteristics, such as display characteristics for various devices, user input options associated with various devices, or communication capabilities of various devices. Based on detecting issues about device compatibility, the response prediction system 106 may suggest changes.

The response prediction system 106 performs act 406 of accessing historical question characteristics and historical question response quality. In particular, the response prediction system 106 accesses the general dataset 308, the specific dataset 310, or both. The general dataset 308 includes historical question characteristics and historical question response qualities of all surveys received by the response prediction system 106. The specific dataset 310 includes historical question characteristics and historical question response qualities for the administrator 302 or entity. As mentioned previously, in at least one embodiment, the specific dataset 310 includes historical question characteristics and historical question response qualities for an entity (e.g., company) associated with the administrator 302. In at least one embodiment, the response prediction system 106 automatically determines whether to access the general dataset 308, the specific dataset 310, or both. In at least one other embodiment, the response prediction system 106 receives input from the administrator 302 indicating which dataset to utilize or requests additional information from the administer that would allow the response prediction system to generate or create a specific dataset that is more customized for the particular survey.

In at least one embodiment, the response prediction system 106 can increase the accuracy of question response quality predictions by filtering accessed survey data based on question type. For example, multiple-choice questions can often contain more words than text entry questions before the response quality decreases. Thus, based on determining that the received question is a multiple-choice question, the response prediction system 106 may access only historical survey data for multiple choice questions.

As part of performing act 402 of predicting question response quality, the response prediction system 106 also performs act 408 of comparing question characteristics. In at least one embodiment, the response prediction system 106 utilizes a machine learning model to compare question characteristics. In particular, the machine learning model is trained using historical question characteristics and historical question response quality. The trained machine learning model uses, as input, the extracted question characteristics to generate predicted question response quality. For example, the response prediction system 106 might determine that responses to the received question are likely to be irrelevant based on a combination of a low readability index score, a high number of coordinating conjunctions (e.g., and, but, or), and a high word count.

In at least one embodiment, the response prediction system 106 utilizes a statistical model to perform act 408 of comparing question characteristics. For example, the response prediction system 106 can perform a regression analysis on the received survey question based on historical question characteristics and historical question response quality to generate the question response quality. In at least one embodiment, the response prediction system 106 utilizes a combination of the statistical model and the machine learning model to compare the question characteristics. The response prediction system 106 can determine whether to utilize the statistical model, the machine learning model, or a combination of both.

As mentioned, the response prediction system 106 utilize a statistical model to generate rules for regression analysis. For example, the response prediction system 106 can utilize the statistical model for characteristics with linear correlations with question response qualities. For example, questions with low readability index (e.g., gunning fog) scores might be directly correlated with low question completion rate or low response relevance. Additionally, the response prediction system 106 can conduct further regression analysis by segmenting the survey data into finer groups. For example, in at least one embodiment, the response prediction system 106 maps the historical question characteristics and historical question response quality in a vector space and utilizes K-means clustering to identify clusters of characteristics. Thus, the response prediction system 106 can infer more sophisticated rules from the historical question characteristics and historical question response quality. The response prediction system 106 also utilizes the statistical model in act 420 of comparing global survey characteristics.

The response prediction system 106, as part of act 402 predicting question response quality, predicts question response quality for a number of question response quality classes. Example question response quality classes include a predicted question response time (i.e., the time it takes a respondent to complete a question response), response relevance (e.g., how relevant the question response content is to the prompt), question completion rate (e.g., how likely a respondent will complete the question), device compatibility (e.g., whether the question, as written, can be displayed across electronic devices), etc.

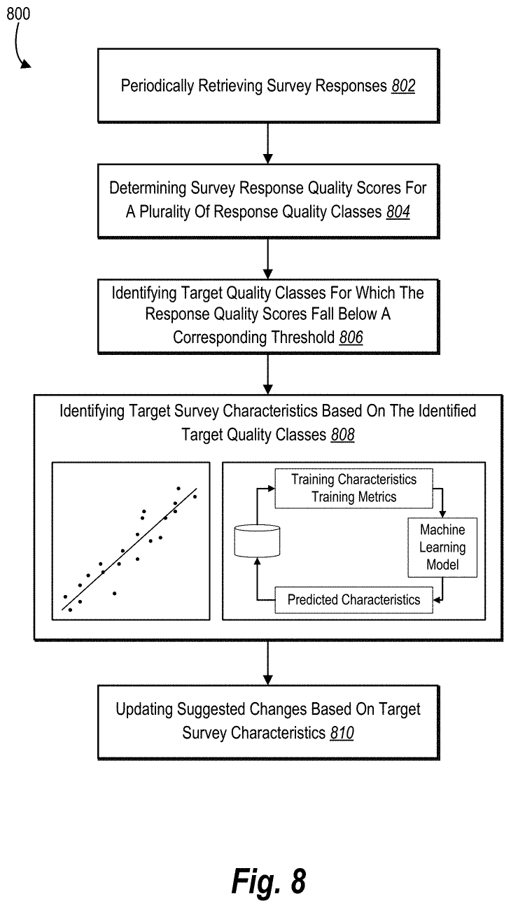

Based on the predicted question response quality, the response prediction system 106 performs act 410 of generating question suggested changes. In general, the response prediction system 106 identifies question characteristics that correspond to target question response quality classes that fall below corresponding thresholds. For example, based on predicting that responses to the received question are likely random and thus meaningless, the response prediction system 106 can suggest a change of decreasing the number of multiple-choice options. More detail on generating question suggested changes will be provided below in the discussion accompanying FIG. 8.

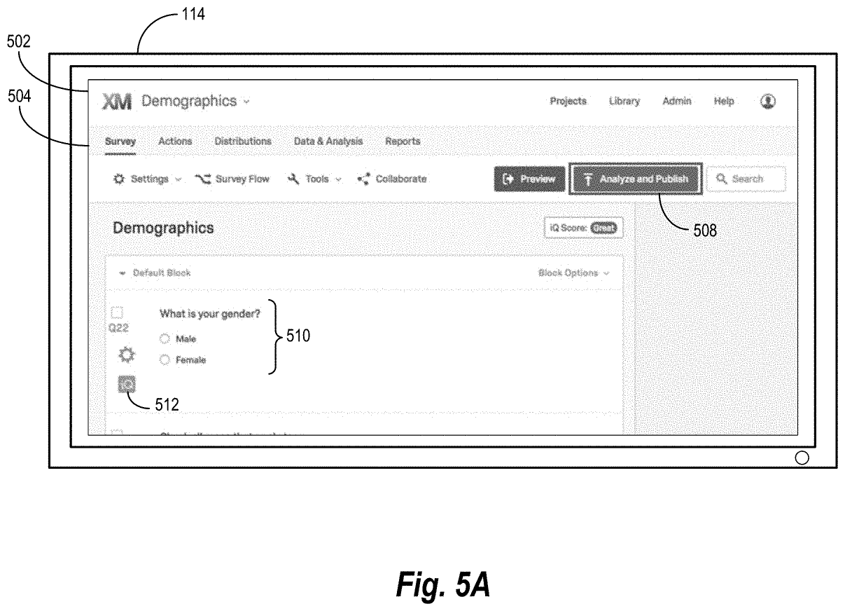

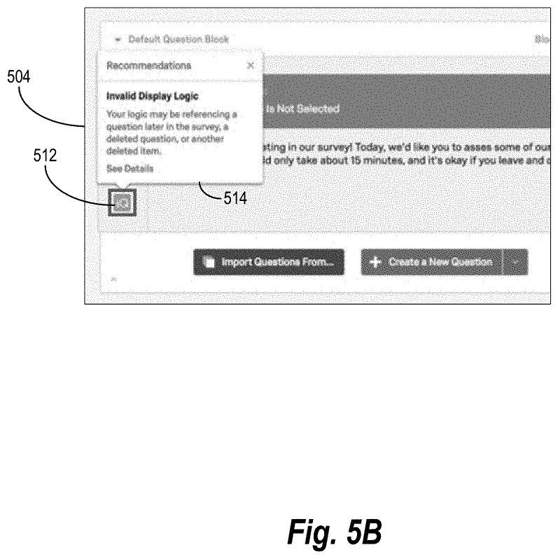

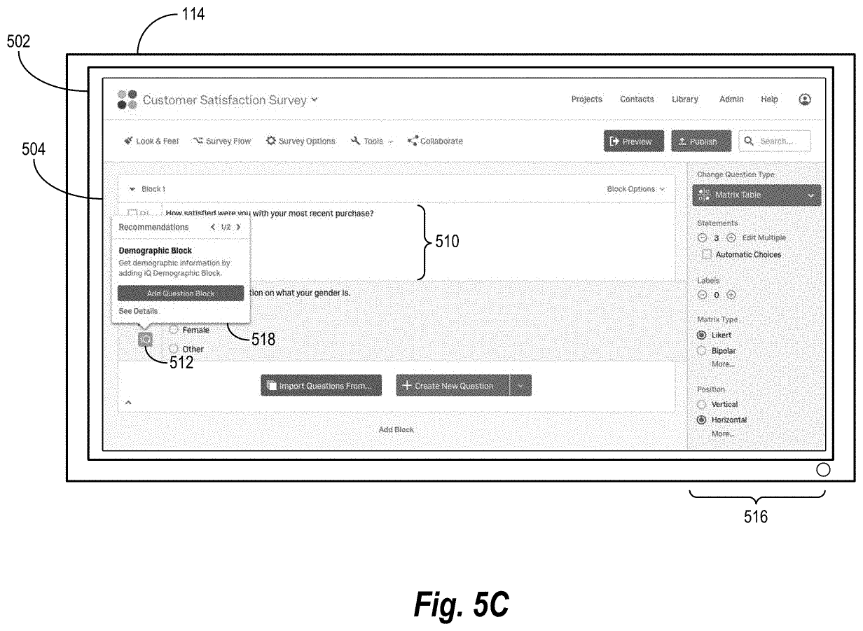

The response prediction system 106 presents the question suggested change in act 412. In general, the response prediction system 106 presents, in real time, suggested changes to improve question response quality to the administrator. Additional detail regarding presenting the question suggested changes via question evaluation graphical user interface will be provided below in the discussion accompanying FIGS. 5A-5C.

FIG. 4 also provides an overview of how the response prediction system 106 generates and presents global survey suggested changes 424. Global survey suggested changes apply to the received survey as a whole. As illustrated, the response prediction system 106 performs act 414 of predicting global survey response quality. Predicting global survey response quality 414 includes act 416 of extracting survey characteristics, act 418 of accessing historical global survey characteristics and historical global survey response quality, and act 420 of comparing global survey characteristics. Based on predicting the global survey response quality 414, the response prediction system 106 performs act 422 of generating global survey suggested changes and act 424 of presenting global survey suggested changes.

As illustrated in FIG. 4, the response prediction system 106 performs act 416 of extracting global survey characteristics. The response prediction system 106 extracts a number of global survey characteristics. Generally, global survey characteristics include number of questions in the survey, question similarity, question progression, counts of each type of questions, and others. Additionally, the response prediction system 106 can extract survey flow characteristics comprising semantic data for each question in combination with the question order. For example, the response prediction system 106 can generate sentence embeddings by utilizing Word2vec algorithms.

The response prediction system 106 performs act 418 of accessing historical global survey characteristics and historical global survey response quality. Act 418 includes steps similar to those in act 406 of accessing historical question characteristics and historical question response quality. Namely, the response prediction system 106 accesses the general dataset 308, the specific dataset 310, or a combination of both to access historical global survey characteristics and historical global survey response quality.

The response prediction system 106 performs act 420 of comparing global survey characteristics. In particular, the response prediction system 106 uses a machine learning model, a statistical model, or a combination of both to compare the extracted global survey characteristics with historical global survey characteristics. For example, similar to how the response prediction system 106 utilizes a machine learning model in act 408 of comparing question characteristics, the response prediction system trains a machine learning model using historical global survey characteristics and historical global survey response quality.

As part of act 414 of predicting global survey response quality, the response prediction system 106 predicts the global survey response quality by determining scores for survey response quality classes. Example survey response quality classes include response flow quality, completion time, completion rate, and survey delivery success. Each of these survey response quality classes will be detailed below. In at least one embodiment, the scores comprise a fractional number indicating a number of predicted responses with (or without) a particular error. For example, the response prediction system 105 might determine that 58/100 survey answers are likely to have answers that are relevant to the prompt.

An example survey response quality class is response flow quality. As part of act 414 of predicting global survey response quality, the response prediction system 106 can predict response flow qualities of the global survey. For example, by evaluating global survey characteristics related to the survey sequence flow, the response prediction system 106 can predict contradicting responses, repetitive/similar responses, and logical response sequencing. To identify contradicting questions, the response prediction system 106 can leverage the sentence embeddings for individual questions and compute cosine similarities with other question sentence embeddings. For example, a cosine value close to −1 indicates that two questions likely contradict. Thus, such questions are likely to yield contradicting responses. Similarly, the response prediction system 106 can identify repetitive/similar responses. For example, question sentence embeddings that have cosine values close to 1 indicate that the two questions are likely similar enough to generate similar, if not the same, responses.

Furthermore, as mentioned, the response prediction system 106 analyzes the sequencing of questions in the global survey as part of predicting the response flow qualities. For example, illogically sequenced questions are likely to yield irrelevant responses because illogically sequenced questions often confuse respondents. In at least one embodiment, the response prediction system 106 utilizes recurrent neural networks such as Long Short-Term Memory (LSTM) or Gated Recurrent Unit (GRU) neural networks to compute whether a question flow is logical or not. In particular, the input embeddings into the recurrent neural network can include question sentence embeddings (e.g., Smoothed Inversed Frequency embeddings) or output from another neural network (e.g., Convolutional Neural Networks or Transformer neural networks).

As mentioned previously, the response prediction system 106 determines scores for the response quality class of completion time. Generally, the response prediction system 106 predicts the amount of time required to complete each question in the survey. The response prediction system 106 identifies every possible response path for a survey and, based on the predicted reading speed, the response prediction system 106 can predict the completion time. In at least one embodiment, the response prediction system 106 uses an average reading speed to calculate the predicted completion time. In at least one other embodiment, the response prediction system 106 accesses past respondent reading speed data to predict reading speed specific to the respondent. Furthermore, the response prediction system 106 can predict reading speed specific to a class of the respondent. In at least one embodiment, the completion time score comprises a time period (e.g., seconds or minutes) predicted to complete the survey.

The response prediction system 106 determines a completion rate score as part of predicting the global survey response quality 414. For example, the response prediction system 106 can predict how what percentage of survey recipients will complete responses to the survey. In particular, in at least one embodiment, the response prediction system 106 predicts completion rates based on a combination of extracted global survey characteristics and recipient data. The response prediction system 106 can condition predicted completion rates on the recipient type. For instance, the response prediction system 106 might predict a higher response rate for paid survey recipients than for recipients reached via social media.

Additionally, the response prediction system 106 generates a score for the survey response quality class of survey delivery success. “Survey delivery success” refers to whether the entire survey can be successfully conveyed to recipients. For instance, a survey that includes one or more questions that cannot be rendered successfully on a recipient's client device will deter the survey recipient from responding. The response prediction system 106 also predicts a low survey delivery success score for translated surveys if translations are missing for particular questions.

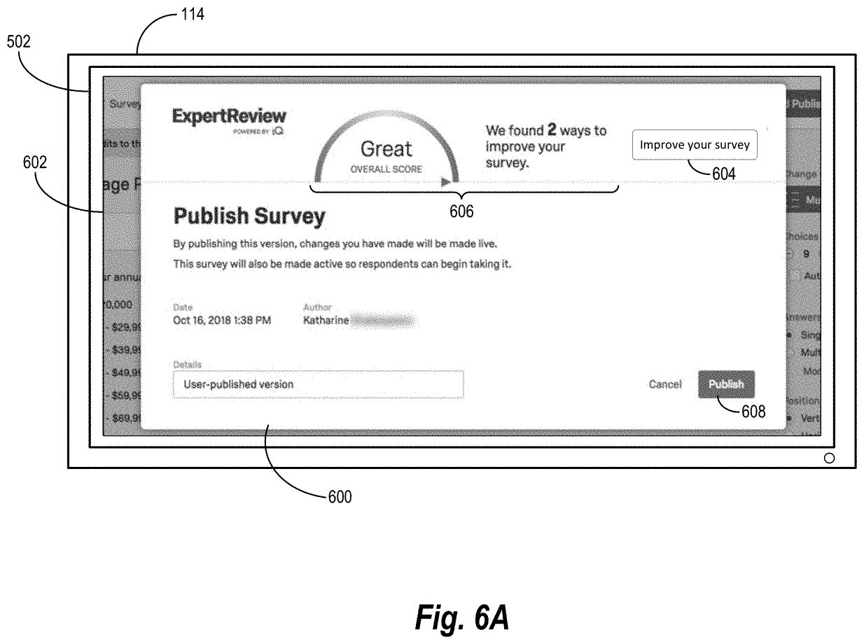

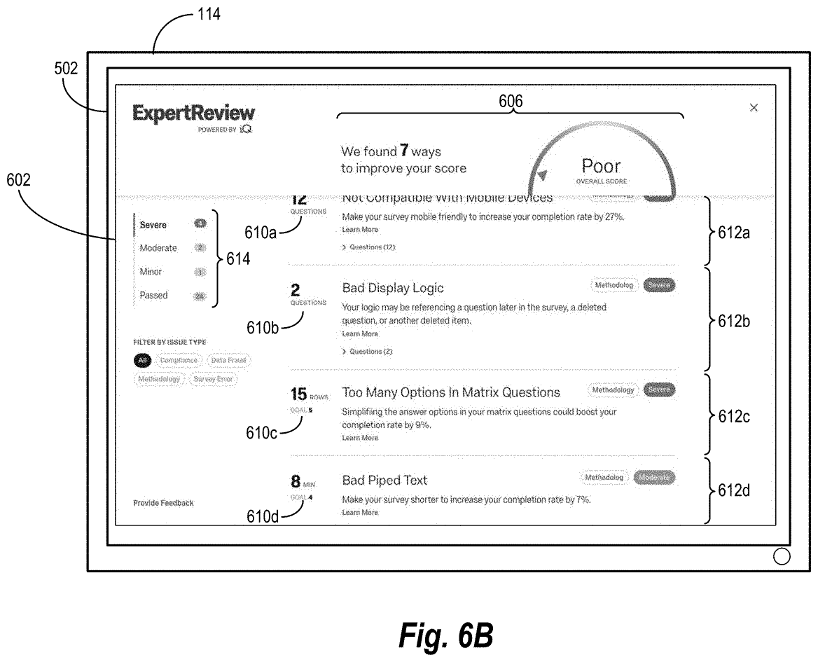

The response prediction system 106 performs act 422 of generating global survey suggested changes. In general, the response prediction system 106 generates global survey suggested changes based on identifying target response quality class for which scores fall below corresponding thresholds and determining target survey characteristics correlated with the target response quality classes. The response prediction system 106 suggests changes based on the target survey characteristics. For example, based on determining that a response flow quality score falls below a response flow quality score threshold (i.e., a target response quality class), the response prediction system 106 identifies target survey characteristics the survey's sequence flow corresponding to the low response flow quality score. As a result, the response prediction system 106 suggests changes such as removing a question, moving a question, or adding a question. In at least one embodiment, the response prediction system 106 uses negative thresholds for evaluating survey response quality class scores. For example, based on determining that predicted completion time is higher than the corresponding threshold (as opposed to lower), the response prediction system 106 can suggest removing questions, changing question types from free text to multiple choice, shortening questions, etc. Additional detail for how the response prediction system 106 generates suggested changes will be provided below in the discussion accompanying FIG. 8. In act 424, the response prediction system 106 presents global survey suggested changes to the administrator 302. Additional detail regarding a survey evaluation graphical user interface will be provided below in the discussion accompanying FIGS. 6A-6B.

As mentioned, the response prediction system 106 generates a question evaluation graphical user interface to present predicted question response quality and suggested changes for received survey questions. FIGS. 5A-5C illustrate a series of example question evaluation graphical user interfaces. FIG. 5A illustrates a question evaluation graphical user interface that displays the received question. FIG. 5B illustrates an example question suggested change when the administrator interacts with a question suggestion element. FIG. 5C illustrates an example survey suggested change presented via the question evaluation graphical user interface.

As illustrated in FIG. 5A, the response prediction system 106 presents the question evaluation graphical user interface 504 via a display screen 502 on the administrator client device 114. The question evaluation graphical user interface includes a global survey analysis element 508, a survey question 510, and a question suggestion element 512.

The question evaluation graphical user interface 504 includes the global survey analysis element 508. Based on user interaction with the global survey analysis element (e.g., user click), the response prediction system 106 updates the graphical user interface to present the survey evaluation graphical user interface illustrated in FIGS. 6A-6B. Thus, based on detection with the global survey analysis element 508, the response prediction system 106 allows the administrator to efficiently navigate from viewing survey question data to viewing global survey data and suggested changes.

The question evaluation graphical user interface 504 also includes the survey question 510. The survey question 510 displays the survey question evaluated by the response prediction system 106. The response prediction system 106 can make real time edits to the survey question 510 based on administrator input. For example, the response prediction system 106 can add a multiple-choice option or change the question. The response prediction system 106 evaluates, in real time, the survey question 510 and presents question suggested changes based on interaction with the question suggestion element 512.

As illustrated, the question suggestion element 512 comprises an interactive element. Based on administrator interaction with the question suggestion element 512, the response prediction system 106 updates the question evaluation graphical user interface 504 to display question suggested changes. In at least one other embodiment, the question suggestion element 512 itself displays a preview of question suggested changes.

FIG. 5B illustrates the question suggested change 514 via the question evaluation graphical user interface 504. As illustrated, based on user interaction with the question suggestion element 512, the response prediction system 106 expands a window that includes the question suggested change 514. The question suggested change 514 presents suggested changes for the survey question 510. For example, the question suggested change 514 can include a suggestion to change the question to stop referencing deleted items. Additionally, the question suggested change 514 can include predicted question response quality. For example, the response prediction system 106 can indicate that responses to the received survey question will likely include personal information (e.g., social security number) and thus render the responses unusable.

The question evaluation graphical user interface 504 can also display global survey response quality and global survey suggested changes for application to specific survey questions. FIG. 5C illustrates the response prediction system 106 presenting a survey suggested change 518 via the question evaluation graphical user interface 504. As illustrated, the survey suggested change 518 includes the suggested change of adding a demographic block. More specifically, the response prediction system 106 identifies when identified global survey suggested changes are associated with specific locations and/or locations. For example, the response prediction system 106 may determine to add one or more questions (e.g., a demographic block) in a particular location. The response prediction system 106 may also identify specific questions for deletion. As illustrated, the response prediction system presents the survey suggested change 518 via the question evaluation graphical user interface 504 for the survey question 510. The question evaluation graphical user interface 504 can also present a question type edit element 516. In particular, based on interaction with the question type edit element 516, the response prediction system 106 can quickly change the question type.

FIGS. 6A-6B illustrate a series of survey evaluation graphical user interfaces that present global survey predicted response quality and global survey suggested changes. FIG. 6A illustrates a survey evaluation notification 600 as part of the survey evaluation graphical user interface 602 via the display screen 502 of the administrator client device 114. The survey evaluation notification 600 includes a response quality summary 606, a publish element 608, and a survey improvement element 604.

As illustrated in FIG. 6A, the response quality summary 606 includes an overall score for the survey and an indication of suggested changes for the survey. For example, as illustrated, the response prediction system 106 indicates that the survey scored “great” overall. The response prediction system 106 can present other general ratings including “perfect,” “good,” “fair,” “poor,” etc. As illustrated in FIG. 6A, the publish element 608 comprises an interactive element. Based on interaction with the publish element 608, the digital survey system 104 publishes the survey to the recipient devices.

Based on interaction with the survey improvement element 604, the response prediction system 106 updates the survey evaluation graphical user interface to present predicted global survey response quality and generated global survey suggested changes. FIG. 6B illustrates the survey evaluation graphical user interface 602 with predicted response quality and generated global survey suggested changes. The survey evaluation graphical user interface of FIG. 6B includes the response quality summary 606, an urgency rating element 614, identified survey elements 610a-610d, and suggested change indicators 612a-612d.

As illustrated in FIG. 6B, the survey evaluation graphical user interface 602 includes the urgency rating element 614. In particular, the urgency rating element 614 provides an overview of number of questions corresponding to target response quality classes. The response prediction system 106 also indicates urgency ratings for the target response quality classes. In particular, the response prediction system 106 assigns urgency ratings based on the difference between the response quality class score and the corresponding threshold. Greater differences between response quality class scores and corresponding thresholds result in poorer ratings. For example, as illustrated in FIG. 6B, the response prediction system 106 indicates, via the survey evaluation graphical user interface 602, that 4 target response quality classes qualify as “severe.” Additional detail regarding urgency ratings will be provided below in the discussion accompanying FIG. 8.

The survey evaluation graphical user interface 602 of FIG. 6B also includes the identified survey elements 610a-610d (collectively “identified survey elements 610”) and the suggested change indicators 612a-612d (collectively “suggested change indicators 612”). The suggested change indicators 612 present suggested changes. By detecting interaction with a suggested change of the suggested change indicators 612, the response prediction system 106 can update the graphical user interface to display a particular question or series of questions. For example, based on detecting user selection of the suggested change indicator 612b, the response prediction system 106 updates the graphical user interface to display the question with bad display logic. In response to detecting user selection of the suggested change indicator 612d, the response prediction system 106 can present a series of survey questions that can be removed to shorten the survey.

The identified survey elements 610 provide an overview of survey elements including survey sequence flow, survey questions and survey question elements (e.g., multiple choice questions, matrix rows) that correspond to the corresponding suggested change indicators 612. The identified survey elements 610 can also comprise interactive elements. Thus, based on selection of an identified survey element 610, the response prediction system 106 updates the graphical user interface to display the indicated survey element.

Based on user interaction with an urgency rating in the urgency rating element 614, the response prediction system 106 updates the survey evaluation graphical user interface 602 to highlight target survey characteristics. The response prediction system 106 presents an efficient graphical user interface that displays, in one user interface, an indication of the predicted response quality via the urgency rating element 614 and suggested changes to improve response quality.

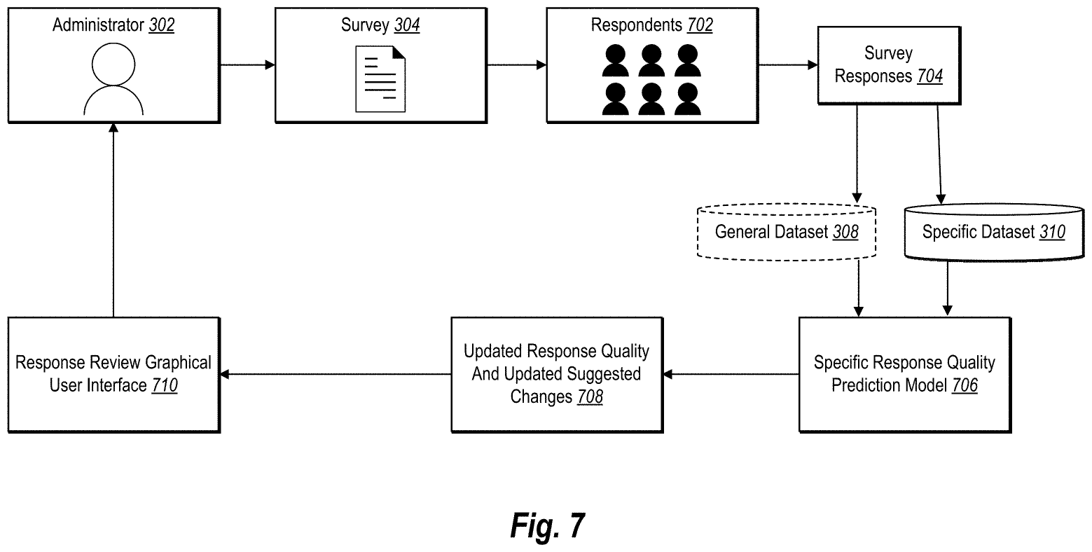

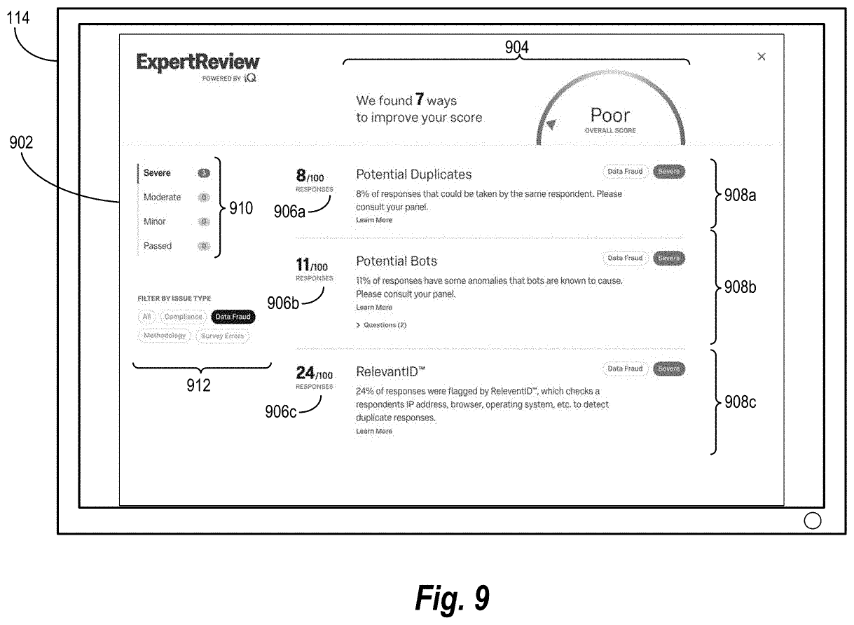

As mentioned previously, the response prediction system 106 updates predicted response quality based on actual received responses. FIGS. 7-9 provide additional detail for updating predicted response quality based on received responses. FIG. 7 provides a general overview for presenting updated response quality and updated suggested changes to the administrator 302. FIG. 8 provides additional detail for how the specific response quality prediction model of the response prediction system 106 generates suggested changes. FIG. 9 provides an example graphical user interface for reporting updated response quality and updated suggested changes.

FIG. 7 provides a general overview for presenting updated response quality and updated suggested changes to the administrator 302. Generally, the response prediction system 106 receives the survey 304 from the administrator 302. The response prediction system 106 sends the survey 304 to respondents 702. The response prediction system 106 receives survey responses 704 from the respondents 702 and stores survey data from the survey responses 704 in the specific dataset 310. Optionally, the response prediction system 106 updates the general dataset 308 using survey response data from the survey responses 704. The response prediction system 106 utilizes a specific response quality prediction model 706 to analyze data in the general dataset 308 and the specific dataset 310 to generate updated response quality and updated suggested changes 708. The response prediction system 106 presents the updated response quality and updated suggested changes 708 to the administrator 302 via a response review graphical user interface 710.

As illustrated in FIG. 7, the response prediction system 106 updates the general dataset 308 by storing survey data from the received survey responses 704. In particular, the response prediction system 106 stores survey characteristics and survey response qualities to aid in future response quality predictions. The response prediction system 106 also stores survey response data from the survey responses 704 in the specific dataset 310. By storing survey characteristics and survey response qualities in the specific dataset 310, the response prediction system 106 improves the accuracy of survey response quality predictions and suggested changes for the administrator 302.

FIG. 8 provides additional detail regarding how the specific response quality prediction model 706 generates updated response quality and recommended changes. Although FIG. 8 and the accompanying discussion are directed to generating updated suggested changes and updated response quality, the processes described in FIG. 8 are also utilized in generating global survey suggested changes and question suggested changes.

FIG. 8 illustrates series of acts 800 for updated suggesting changes after the response prediction system 106 has received some responses. Generally, the series of acts 800 includes act 802 of periodically retrieving survey responses, act 804 of determining survey response quality scores for a plurality of response quality classes, act 806 of identifying target response quality classes for which the response quality scores fall below a corresponding threshold, act 808 of identifying target survey characteristics based on the identified target response quality classes 808 and act 810 of updating suggested changes based on the target survey characteristics 810.

As illustrated in FIG. 8, the response prediction system 106 performs act 802 of periodically retrieving survey responses. Generally, the response prediction system 106 retrieves enough survey responses for a survey to improve the survey. In at least one embodiment, the response prediction system 106 sends the survey 304 to a portion of recipients, updates the survey based on received responses, and sends the survey 304 to the remaining recipients. In at least one other embodiment, the response prediction system 106 sends a survey link associated with the survey 304 to all intended recipients. Based on the passage of a set period of time or a set number of received responses, the response prediction system 106 evaluates the received responses. The response prediction system 106 updates the suggested changes based on the evaluated responses.

The response prediction system 106 performs act 804 of determining survey response quality scores for a plurality of response quality classes 804. The response prediction system 106 analyzes the received responses and extracts actual response quality class scores based on the received responses. For example, the response prediction system 106 may extract an actual completion rate and an actual completion time. Additionally, the response prediction system 106 can identify contradicting responses, repetitive/similar responses, and responses with a low correlation to the prompt purpose.

In particular, the response prediction system 106 can analyze and compare the semantic qualities of a question response to semantic qualities of the question, other question responses within the same survey, and corresponding question responses across survey responses. For example, the response prediction system 106 analyzes semantic qualities of a question response and compares them with semantic qualities of the corresponding question. Based on this analysis, the response prediction system 106 can determine a correlation between a response topic and the question topic. Additionally, the response prediction system 106 analyzes compares semantic qualities between responses within a response to identify questions likely to yield repetitive responses. The response prediction system 106 also analyzes and compares semantic qualities between responses to a particular answer across received responses to identify questions likely to yield superfluous responses.

As illustrated by act 806 of the series of acts 800, the response prediction system 106 identifies target response quality classes for which the response quality scores fall below a corresponding threshold. The response prediction system 106 determines threshold values using a variety of methods. For instance, the response prediction system 106 can receive the threshold values from the administrator 304. More specifically, the response prediction system 106 can present, to the administrator 304, response quality classes, and receives threshold values corresponding to each response quality class. The response prediction system 106 allows the administrator 304 to adjust threshold values. For example, if an administrator is especially interested in a high completion rate, the administrator can adjust the threshold to yield a higher completion rate.

In at least one other embodiment, the response prediction system 106 determines threshold values for each response quality class based on historical survey data. The response prediction system 106 can retrieve historical survey data from the general dataset 308 and/or the specific dataset 310. In particular, the response prediction system 106 can identify, using a specific dataset, whether an audience in particular is likely to send responses with specific response quality deficits. Additionally, based on historical data retrieved from the specific dataset, the response prediction system 106 can determine a threshold value based on retrieved median, means, and standard deviations from the historical survey data. For example, the response prediction system 106 can determine that the threshold value comprises a deviation value from the mean.

As part of act 806 of identifying target response quality classes for which the response quality scores fall below a corresponding threshold, the response prediction system 106 compares the scores of the determined response quality classes with their corresponding classes. In at least one embodiment, identifying target response quality classes comprises a binary identification. In at least one other embodiment, the response prediction system 106 generates a scale of target response quality classes. For example, all response quality classes for which the response quality scores fall below (or above) the corresponding threshold qualify as target response quality classes. The response prediction system 106 assigns urgency ratings to each of the target response quality classes. The urgency ratings can range from “severe” to “fair” based on the deviation of the response quality score from the corresponding threshold. As illustrated above with respect to FIG. 6B, the response prediction system 106 can present the urgency rating as part of the survey evaluation graphical user interface 602.

The response prediction system 106 performs act 808 of identifying target survey characteristics based on the identified survey classes. The response prediction system 106 identifies target survey characteristics that, if adjusted, will specifically improve the target response quality classes. As illustrated in FIG. 8, the response prediction system 106 identifies target survey characteristics using a statistical regression analysis, a machine learning model, or both.

In at least one embodiment, the response prediction system 106 utilizes a statistical regression analysis to identify target survey characteristics based on the identified target response quality classes. More particularly, the response prediction system 106 analyzes the extracted survey characteristics to identify characteristics that, when changed, will improve the target response quality class score. For instance, the response prediction system 106 can analyze historical survey data stored in the general dataset 308 and the specific dataset 310 to identify which survey characteristics are correlated with the target response quality classes. The response prediction system 106 compares the survey characteristics identified through statistical analysis with the extracted survey characteristics and designates overlapping characteristics as target survey characteristics. For example, based on identifying a poor delivery success rate as a target response quality class, the response prediction system 106 analyzes past survey data associated with poor delivery success rate. The response prediction system 106 determines that common survey characteristics associated with a poor survey delivery success score include missing translations for one or more questions, questions formatted a certain way, and other characteristics. The response prediction system 106 analyzes the extracted survey characteristics to identify survey characteristics associated with poor survey delivery success scores and designates these survey characteristics as target survey characteristics.

As illustrated in FIG. 8, The response prediction system 106 also utilizes a machine learning model to perform act 808 of identifying target survey characteristics based on the identified target quality classes. In particular, the response prediction system 106 can further train the machine learning model based on received survey responses. In particular, the response prediction system 106 trains the machine learning model to generate customized target survey characteristics specific to the administrator 304, the associated entity, or other administrators with characteristics similar to the administrator 304. For example, the machine learning model is trained using training characteristics and training response quality class scores. Based on receiving the target survey characteristics as input, the machine learning model generates target survey characteristics.

Though not illustrated, in at least one embodiment, the response prediction system 106 identifies target survey characteristics based fixed optimal survey characteristics. Instead of (or in addition to) performing act 806 of identifying target response quality classes for which the response quality scores fall below a corresponding threshold, the response prediction system 106 directly compares survey characteristics with fixed optimal survey characteristics. More particularly, the response prediction system 106 identifies target survey characteristics based on which survey characteristics diverge from the fixed optimal survey characteristics. The response prediction system 106 can identify optimal survey characteristics (i.e., question characteristics and global survey characteristics) that apply to all surveys. For example, the response prediction system 106 can identify an optimal survey completion time (e.g. 7 minutes). Other examples of survey characteristics that the response prediction system 106 may identify fixed optimal survey characteristics include an optimal number of polysyllabic words for each type of question (e.g., matrix, text entry, multiple choice, etc.), an optimal number of words for each type of question, an optimal readability score (e.g., gunning fog index), the number of coordinating conjunctions for each type of question, and the number of characters for each type of question. Similarly, the response prediction system 106 can generate question suggested changes 410 based directly on the extracted question characteristics. Although not illustrated above, the response prediction system 106 can utilize optimal survey characteristics during act 410 of generating question suggested changes and act 422 of generating global survey suggested changes.

The response prediction system 106 performs act 810 of updating suggested changes based on target survey characteristics. Generally, the response prediction system 106 accesses the suggested changes presented during the creation of the survey. The response prediction system 106 updates the suggested changes and presents them to the administrator 304 via a response evaluation graphical user interface.

As mentioned, the response prediction system 106 presents updated response quality and updated suggested changes to the administrator 304 via a response evaluation graphical user interface. FIG. 9 illustrates an example response evaluation graphical user interface 902 on the administrator client device 114. The response evaluation graphical user interface 902 includes various elements including an actual response quality summary 904, response quality class scores 906a-906c (collectively “response quality class scores 906”), updated suggested changes indicators 908a-908c (collectively “updated suggested changes indicators 908”), actual urgency ratings element 910, and filter element 912.

The response evaluation graphical user interface 902 includes the actual response quality summary 904. The actual response quality summary 904 appears similar to the response quality summary 606 of the survey evaluation graphical user interface 602. However, whereas the response quality summary 606 provides an overview of predicted response quality, the actual response quality summary 904 presents actual response quality for retrieved responses. In particular, the actual response quality summary 904 includes an overall score for the received responses (e.g., “poor”) and an indication of suggested changes (e.g., “We found 7 ways to improve your score”).

The response evaluation graphical user interface 902 also includes the response quality class scores 906. In particular, the response quality class scores 906 include scores for individual response quality classes. For example, the response quality class score 908a indicates that 8/100 responses are potential duplicates (i.e., repetitive answers across survey responses). As illustrated, the response prediction system 106 also identifies and reports responses from potential bots via response quality class score 906b.

The updated suggested changes indicators 908 present target response quality classes and suggested changes. In addition to providing an indication of target response quality class type, the updated suggested changes indicators 908 also include an urgency ranking associated with each target response quality class.

As illustrated in FIG. 9, the response evaluation graphical user interface 902 also includes a filter element 912. The filter element 912 enables the response prediction system 106 to collect user feedback to filter by issue type. For example, the response prediction system 106 can present the target response quality classes in order by type. As illustrated in FIG. 9, the response prediction system 106 identifies compliance, data fraud, methodology, and survey errors as different types.

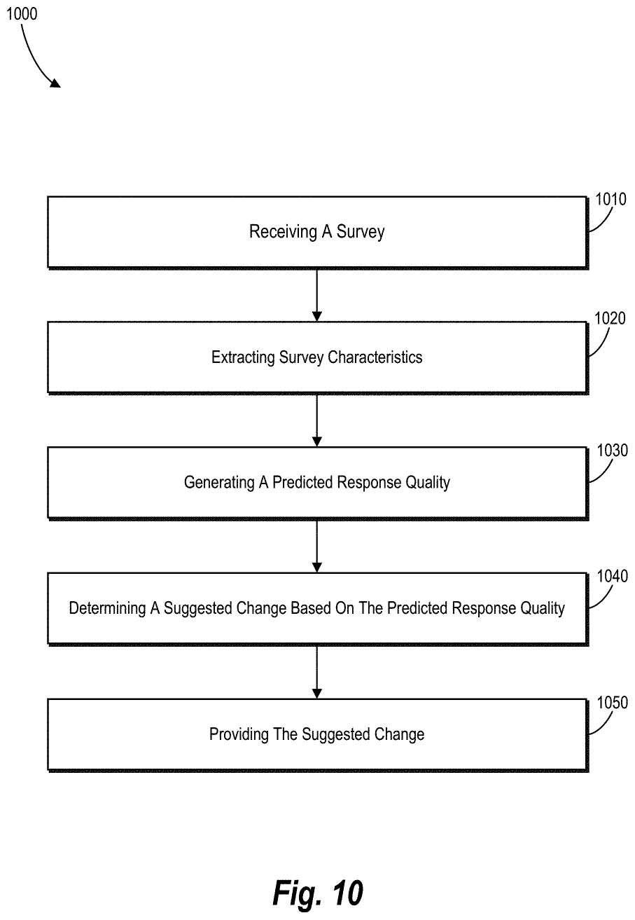

FIGS. 1-9, the corresponding text, and the examples provide a number of different methods, systems, devices, and non-transitory computer-readable media of the question recommendation system 106 in accordance with one or more embodiments. In addition to the above description, one or more embodiments can also be described in terms of flowcharts including acts for accomplishing a particular result. For example, FIG. 10 illustrates flowcharts of an exemplary sequence of acts for providing a suggested survey prompt in accordance with one or more embodiments. FIG. 10 may be performed with more or fewer acts. Further, the acts may be performed in differing orders. Additionally, the acts described herein may be repeated or performed in parallel with one another or parallel with different instances of the same or similar acts.

While FIG. 10 illustrates series of acts according to particular embodiments, alternative embodiments may omit, add to, reorder, and/or modify any of the acts shown in FIG. 10. The series of acts of FIG. 10 can be performed as part of a method. Alternatively, a non-transitory computer-readable medium can comprise instructions, that when executed by one or more processors, cause a computing device to perform the series of acts of FIG. 10. In still further embodiments, a system can perform the acts of FIG. 10. In addition, in one or more embodiments, the series of acts 1000 is implemented on one or more computing devices, such as the server device 102 and/or the administrator client device 114.

The series of acts 1000 includes act 1010 of receiving a survey. In particular, act 1010 can include receiving, from a client device associated with an administrator, a survey comprising survey questions. The series of acts 1000 includes act 1020 of extracting survey characteristics. In particular, act 1020 includes extracting survey characteristics based on the survey and the survey questions. As illustrated in FIG. 10, the series of acts 1000 also includes act 1030 of generating a predicted response quality. In particular, act 1030 includes generating, based on the survey characteristics, a predicted response quality corresponding to the survey. More specifically, act 1030 can include predicting the response quality and suggested changes by utilizing a machine learning model trained using a general dataset. In at least one embodiment, the predicted response quality comprises a predicted survey completion rate.

The series of acts 1000 includes act 1040 of determining a suggested change based on the predicted response quality. In particular, act 1040 includes determining, based on the predicted response quality, a suggested change to the survey. The series of acts 1000 includes act 1050 of providing the suggested change. Act 1050 includes providing the suggested change to the client device associated with the administrator. Act 1050 can include an additional act of providing the suggested change by providing a question-specific suggested change for a survey question of the survey questions. Additionally, act 1050 can include an additional act of providing the suggested change by providing a global survey suggested change for the survey.

The series of acts 1000 can include additional acts including publishing, to one or more client devices associated with respondents, the survey; receiving, from the one or more client devices, survey response data; generating an updated response quality; determining, based on the updated response quality, an updated suggested change to the survey; and providing the updated response quality and the updated suggested change to the client device associated with the administrator. In at least one embodiment, the additional act includes an act of generating the updated response quality by utilizing a machine learning model trained using a specific dataset. In particular, this act can include additional acts of analyzing the survey response data; determining that a number of responses within a target response class meets a threshold; and identifying a suggested change corresponding to the target response class. Additionally, this act includes additional acts of generating the updated response quality based on the survey response data by analyzing the survey response data; and determining a number of target responses. In at least one embodiment, this act includes additional acts of analyzing the survey response data; and determining a number of target responses. The series of acts 1000 can include an additional act of providing the predicted response quality to the client device associated with the administrator.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., memory), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices), or vice versa. For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed by a processor, cause a general-purpose computer, special purpose computer, or special purpose processing device to perform a certain function or group of functions. In some embodiments, computer-executable instructions are executed by a general-purpose computer to turn the general-purpose computer into a special purpose computer implementing elements of the disclosure. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. As used herein, the term “cloud computing” refers to a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In addition, as used herein, the term “cloud-computing environment” refers to an environment in which cloud computing is employed.

FIG. 11 illustrates a block diagram of a computing device 1100 that may be configured to perform one or more of the processes described above associated with the response prediction system 106. One will appreciate that one or more computing devices, such as the computing device 1100 may represent the computing devices described above (e.g., the server device 102, the administrator client device 114, and the recipient client device 118). In one or more embodiments, the computing device 1100 may be a non-mobile device (e.g., a desktop computer or another type of client device). In some embodiments, the computing device 1100 may be a mobile device (e.g., a mobile telephone, a smartphone, a PDA, a tablet, a laptop, a camera, a tracker, a watch, a wearable device, etc.). Further, the computing device 1100 may be a server device that includes cloud-based processing and storage capabilities.

As shown in FIG. 11, the computing device 1100 can include one or more processor(s) 1102, memory 1104, a storage device 1106, input/output interfaces 1108 (or simply “I/O interfaces 1108”), and a communication interface 1110, which may be communicatively coupled by way of a communication infrastructure (e.g., bus 1112). While the computing device 1100 is shown in FIG. 11, the components illustrated in FIG. 11 are not intended to be limiting. Additional or alternative components may be used in other embodiments. Furthermore, in certain embodiments, the computing device 1100 includes fewer components than those shown in FIG. 11. Components of the computing device 1100 shown in FIG. 11 will now be described in additional detail.

In particular embodiments, the processor(s) 1102 includes hardware for executing instructions, such as those making up a computer program. As an example, and not by way of limitation, to execute instructions, the processor(s) 1102 may retrieve (or fetch) the instructions from an internal register, an internal cache, memory 1104, or a storage device 1106 and decode and execute them.

The computing device 1100 includes memory 1104, which is coupled to the processor(s) 1102. The memory 1104 may be used for storing data, metadata, and programs for execution by the processor(s). The memory 1104 may include one or more of volatile and non-volatile memories, such as Random-Access Memory (“RAM”), Read-Only Memory (“ROM”), a solid-state disk (“SSD”), Flash, Phase Change Memory (“PCM”), or other types of data storage. The memory 1104 may be internal or distributed memory.

The computing device 1100 includes a storage device 1106 includes storage for storing data or instructions. As an example, and not by way of limitation, the storage device 1106 can include a non-transitory storage medium described above. The storage device 1106 may include a hard disk drive (HDD), flash memory, a Universal Serial Bus (USB) drive or a combination these or other storage devices.

As shown, the computing device 1100 includes one or more I/O interfaces 1108, which are provided to allow a user to provide input to (such as user strokes), receive output from, and otherwise transfer data to and from the computing device 1100. These I/O interfaces 1108 may include a mouse, keypad or a keyboard, a touch screen, camera, optical scanner, network interface, modem, other known I/O devices or a combination of such I/O interfaces 1108. The touch screen may be activated with a stylus or a finger.

The I/O interfaces 1108 may include one or more devices for presenting output to a user, including, but not limited to, a graphics engine, a display (e.g., a display screen), one or more output drivers (e.g., display drivers), one or more audio speakers, and one or more audio drivers. In certain embodiments, I/O interfaces 1108 are configured to provide graphical data to a display for presentation to a user. The graphical data may be representative of one or more graphical user interfaces and/or any other graphical content as may serve a particular implementation.

The computing device 1100 can further include a communication interface 1110. The communication interface 1110 can include hardware, software, or both. The communication interface 1110 provides one or more interfaces for communication (such as, for example, packet-based communication) between the computing device and one or more other computing devices or one or more networks. As an example, and not by way of limitation, communication interface 1110 may include a network interface controller (NIC) or network adapter for communicating with an Ethernet or other wire-based network or a wireless NIC (WNIC) or wireless adapter for communicating with a wireless network, such as a WI-FI. The computing device 1100 can further include a bus 1112. The bus 1112 can include hardware, software, or both that connects components of computing device 1100 to each other.

FIG. 12 illustrates a network environment 1200 of a digital survey management system 1204, such as embodiments of the response prediction system 106 within the digital survey system 104, as described herein. The network environment 1200 includes the digital survey management system 1204 and a client system 1208 connected to each other by a network 1206. Although FIG. 12 illustrates a particular arrangement of the digital survey management system 1204, the client system 1208, and the network 1206, one will appreciate that other arrangements of the network environment 1200 are possible. For example, a client device of the client system 1208 is directly connected to the digital survey management system 1204. Moreover, this disclosure contemplates any suitable number of client systems, digital survey systems, and networks are possible. For instance, the network environment 1200 includes multiple client systems.

This disclosure contemplates any suitable network. As an example, one or more portions of the network 1206 may include an ad hoc network, an intranet, an extranet, a VPN, a LAN, a wireless LAN, a WAN, a wireless WAN, a MAN, a portion of the Internet, a portion of the Public Switched Telephone Network (PSTN), a cellular telephone network, a safelight network, or a combination of two or more of these. The term “network” may include one or more networks and may employ a variety of physical and virtual links to connect multiple networks together.

In particular embodiments, the client system 1208 is an electronic device including hardware, software, or embedded logic components or a combination of two or more such components and capable of carrying out the appropriate functionalities implemented or supported by the client system. As an example, the client system 1208 includes any of the computing devices discussed above. The client system 1208 may enable a user at the client system 1208 to access the network 1206. Further, the client system 1208 may enable a user to communicate with other users at other client systems.

In some embodiments, the client system 1208 may include a web browser, such as and may have one or more add-ons, plug-ins, or other extensions. The client system 1208 may render a web page based on the HTML files from the server for presentation to the user. For example, the client system 1208 renders the graphical user interface described above.

In one or more embodiments, the digital survey management system 1204 includes a variety of servers, sub-systems, programs, modules, logs, and data stores. In some embodiments, digital survey management system 1204 includes one or more of the following: a web server, action logger, API-request server, relevance-and-ranking engine, content-object classifier, notification controller, action log, third-party-content-object-exposure log, inference module, authorization/privacy server, search module, user-targeting module, user-interface module, user-profile store, connection store, third-party content store, or location store. The digital survey system 104 may also include suitable components such as network interfaces, security mechanisms, load balancers, failover servers, management-and-network-operations consoles, other suitable components, or any suitable combination thereof.

In the foregoing specification, the invention has been described with reference to specific exemplary embodiments thereof. Various embodiments and aspects of the invention(s) are described with reference to details discussed herein, and the accompanying drawings illustrate the various embodiments. The description above and drawings are illustrative of the invention and are not to be construed as limiting the invention. Numerous specific details are described to provide a thorough understanding of various embodiments of the present invention.

The present invention may be embodied in other specific forms without departing from its spirit or essential characteristics. The described embodiments are to be considered in all respects only as illustrative and not restrictive. For example, the methods described herein may be performed with fewer or more steps/acts or the steps/acts may be performed in differing orders. Additionally, the steps/acts described herein may be repeated or performed in parallel to one another or in parallel to different instances of the same or similar steps/acts. The scope of the invention is, therefore, indicated by the appended claims rather than by the foregoing description. All changes that come within the meaning and range of equivalency of the claims are to be embraced within their scope.

We claim:

1. A system comprising:
at least one processor;
at least one non-transitory computer readable storage medium storing instructions that, when executed by the at least one processor, cause the system to:
receive, from a client device associated with an administrator, a survey comprising survey questions;
extract survey characteristics based on the survey and the survey questions;
generate, based on the survey characteristics, a predicted response quality corresponding to the survey;
determine, based on the predicted response quality, a suggested change to the survey; and
provide the suggested change to the client device associated with the administrator.

2. The system of claim 1, further comprising instructions that, when executed by the at least one processor, cause the system to:
publish, to one or more client devices associated with respondents, the survey;
receive, from the one or more client devices, survey response data;
generate an updated response quality;
determine, based on the updated response quality, an updated suggested change to the survey; and
provide the updated response quality and the updated suggested change to the client device associated with the administrator.

3. The system of claim 2 further comprising instructions that, when executed by the at least one processor, cause the system to generate the updated suggested changes based on the survey response data by:
analyzing the survey response data;
determining that a number of responses within a target response class meets a threshold; and
identifying a suggested change corresponding to the target response class.

4. The system of claim 2 further comprising instructions that, when executed by the at least one processor, cause the system to generate the updated response quality by utilizing a machine learning model trained using a specific dataset.

5. The system of claim 1, further comprising instructions that, when executed by the at least one processor, cause the system to provide the predicted response quality to the client device associated with the administrator.

6. The system of claim 3, wherein the predicted response quality comprises a predicted survey completion rate.

7. The system of claim 1 further comprising instructions that, when executed by the at least one processor, cause the system to predict the response quality and the suggested change by utilizing a machine learning model trained using a general dataset.

8. The system of claim 1 further comprising instructions that, when executed by the at least one processor, cause the system to provide the suggested change by providing a question-specific suggested change for a survey question of the survey questions.

9. The system of claim 1 further comprising instructions that, when executed by the at least one processor, cause the system to provide the suggested change by providing a global survey suggested change for the survey as a whole.

10. The system of claim 1 further comprising instructions that, when executed by the at least one processor, cause the system to generate the updated response quality based on the survey response data by:
analyzing the survey response data; and
determining a number of target responses.

11. A computer-implemented method comprising:
receiving, from a client device associated with an administrator, a survey comprising survey questions;
extracting survey characteristics based on the survey and the survey questions;
generating, based on the survey characteristics, a predicted response quality corresponding to the survey;
determining, based on the predicted response quality, a suggested change to the survey; and
providing the suggested change to the client device associated with the administrator.

12. The computer-implemented method of claim 11 further comprising:
publishing, to one or more client devices associated with respondents, the survey;
receiving, from the one or more client devices, survey response data;
generate an updated response quality;
determining, based on the updated response quality, an updated suggested change to the survey; and
providing the updated response quality and the updated suggested change to the client device associated with the administrator.

13. The computer-implemented method of claim 12, further comprising generating the updated response quality by utilizing a machine learning model trained using a specific dataset.

14. The computer-implemented method of claim 11, further comprising predicting the response quality and the suggested change by utilizing a machine learning model trained using a general dataset.

15. The computer-implemented method of claim 11 further comprising providing the suggested change by providing a question-specific suggested change for a survey question of the survey questions.

16. A non-transitory computer-readable medium storing instructions that, when executed by at least one processor, cause a computer system to:
receive, from a client device associated with an administrator, a survey comprising survey questions;
extract survey characteristics based on the survey and the survey questions;
generate, based on the survey characteristics, a predicted response quality corresponding to the survey;
determine, based on the predicted response quality, a suggested change to the survey; and
provide the suggested change to the client device associated with the administrator.

17. The non-transitory computer-readable medium of claim 16, further storing instructions that, when executed by the at least one processor, cause the computer system to:
publish, to one or more client devices associated with respondents, the survey;
receive, from the one or more client devices, survey response data;
generate an updated response quality;
determine, based on the updated response quality, an updated suggested change to the survey; and
provide the updated response quality and the updated suggested change to the client device associated with the administrator.

18. The non-transitory computer-readable medium of claim 16, further storing instructions that, when executed by the at least one processor, cause the system to predict the response quality and the suggested change.

19. The non-transitory computer-readable medium of claim 16, further storing instructions that, when executed by the at least one processor, cause the system to predict the response quality and the suggested change by utilizing a machine learning model trained using a general dataset.

20. The non-transitory computer-readable medium of claim 16, further storing instructions that, when executed by the at least one processor, cause the system to provide the suggested change by providing a question-specific suggested change for a survey question of the survey questions.
